(19) United States
(12) Patent Application Publication
(10) Pub. No.: US 2013/0297424 A1
(43) Pub. Date: Nov. 7, 2013

(54) METHODS AND APPARATUS TO AUTOMATE HAGGLING BEFORE PHYSICAL POINT-OF-SALE COMMERCE

(71) Applicants: Jim S. Baca, Corrales, MX (US); Selim Aissi, Beaverton, OR (US); Mark H. Price, Placitas, MX (US); David Stanasolovich, Albuquerque, MX (US); Burges M. Karkaria, San Jose, CA (US)

(72) Inventors: Jim S. Baca, Corrales, MX (US); Selim Aissi, Beaverton, OR (US); Mark H. Price, Placitas, MX (US); David Stanasolovich, Albuquerque, MX (US); Burges M. Karkaria, San Jose, CA (US)

(21) Appl. No.: 13/996,648

(22) PCT Filed: Aug. 19, 2011
(86) PCT No.: PCT/US11/48502

§ 371 Date: Jun. 21, 2013

(51) Int. Cl. G06Q 30/06

(52) U.S. Cl. CPC G06Q 30/0611
USPC 705/14.58; 705/26.4; 705/16

(57) ABSTRACT

In one example embodiment of a method for automating business negotiations, a vendor offers a product for sale at an original price. Subsequently, an automated haggling system receives a counteroffer to buy the product from a mobile device controlled by a shopper. The counteroffer proposes a second price for the product. In response to the counteroffer, the automated haggling system automatically determines whether the second price is acceptable. This determination may be based on data from a negotiation database with data identifying acceptable reduced prices. If the counteroffer proposes an acceptable price, the automated haggling system sends a message to the mobile device of the shopper to signify acceptance the counteroffer. In response to a determination that the shopper is purchasing the product at a point-of-sale (POS) station, the POS station automatically charges the shopper the negotiated price tier the product. Other embodiments are described and claimed.

### TECHNICAL FIELD

The present subject matter relates in general to data processing. More particularly, the present subject matter relates to technology for enabling automated haggling in connection with physical point-of-sale commerce.

### BACKGROUND

Vendors typically offer products for sale at list price. From time to time, vendors may also offer products for sale at discounted or reduced prices. In either case, the price at which the vendor offers a product for sale may be referred to as the asking price.

In some environments, vendors have been known to entertain counteroffers. In other words, a vendor may allow a shopper to negotiate or haggle for price below the asking price. For instance, if a used car dealer has a car offered for sale at $9,999, the used car dealer may entertain counteroffers. Accordingly, if a shopper makes a counteroffer to purchase the car for $9,500, the dealer may accept the counteroffer, and the sale may be consummated at the negotiated price.

However, in many environments, vendors do not entertain counteroffers. For instance, the typical grocery store, restaurant, clothing store, or hardware store does not accept haggling. If a typical clothing store has a shirt offered for sale at a price of $20, to purchase the shirt, a shopper must pay the clothing store $20. Many other kinds of stores also do not haggle.

Furthermore, heretofore, haggling has been a manual process, in that the human beings on each side of a transaction must make the decisions as to whether to accept an offer, whether to make a counteroffer, whether to accept the counteroffer, etc.

### SUMMARY

This disclosure describes one or more embodiments of a method for automating business negotiations. Similarly, this disclosure describes one or more embodiments of an automated haggling system. For purposes of this disclosure, to “haggle” is to negotiate over the price and/or any of the other sales terms associated with a proposed business transaction.

According to one example scenario involving one example embodiment, after a vendor has offered a product for sale at an original price, the automated haggling system receives a counteroffer to buy the product from a data processing system controlled by a shopper, wherein the counteroffer proposes a second price for the product. In response to the counteroffer, the automated haggling system automatically determines whether the counteroffer proposes an acceptable price. In response to determining that the counteroffer proposes an acceptable price, a message is sent to the data processing system of the shopper to signify acceptance the counteroffer. In response a determination that the shopper is purchasing the product at a point-of-sale (POS) station, the POS station automatically charges the shopper the second price for the product.

In one embodiment, the automated haggling system determines whether the proposed price is acceptable based on data from a negotiation database with product discount data that identifies a predetermined reduced price for the product as acceptable to the vendor.

Other embodiments are described and claimed, including corresponding program products and data processing systems.

### BRIEF DESCRIPTION OF THE DRAWINGS

Features and advantages of the present invention will become apparent from the appended claims, the following detailed description of one or more example embodiments, and the corresponding figures, in which:

FIG. 1 is a block diagram of an example embodiment of a computing environment to provide an automated haggling service;

FIG. 2 is a flowchart depicting an example embodiment of a process to provide automated haggling services; and

FIGS. 3A & 3B present a flowchart of an example embodiment of a process for using automated haggling services to shop.

### DETAILED DESCRIPTION OF ONE OR MORE EMBODIMENTS

According to at least one embodiment, a vendor uses an automated haggling system to provide for automated negotiations with shoppers. The vendor may offer a product for sale at a particular price, known as the asking price or the original price. However, a shopper may then use the automated haggling system to negotiate a reduced price for that product. Furthermore, there is no need for a human being to participate on the side of the vendor during the haggling process. Instead, the vendor may pre-populate a negotiation database with various acceptable negotiating parameters, such as a minimum acceptable price for the product, and then the automated haggling system may use the negotiation database to automatically determine whether or not to accept a counteroffer from a shopper. The negotiation database may also be referred to as a haggle database. As described in greater detail below, the automated haggling system may also provide many additional useful features, such as automatic counteroffers from the vendor to the shopper, enticement offers, combination offers, and multi-vendor offers. Participating in these kinds of automated negotiations may be referred to as electronic haggling or eHaggling. According to at least one embodiment, a shopper may electronically haggle with a retailer while in the physical store of the retailer, but without interacting with any human representatives of the retailer.

Without an automated haggling system, if a vendor is offering a product for sale at a particular “original” price, a shopper may need to find a coupon for that product and bring that coupon to the store to obtain a discount below the original price. Accordingly, to offer such coupons via newspaper, email, a website, etc., the vendor may need to advertise the coupons and pay various sources to communicate the coupons. For coupons provided electronically, the shopper needs to remember to print the coupon and take it to the store to receive the discount. Also, when shoppers get to the store, they can only take advantage of discounts on those particular items that the vendor has already marked down or for which the customers have coupons. In some situations, however, vendors would be willing to sell products at reduced prices, if the cost, inconvenience, and other disadvantages associated with negotiating prices with shoppers were not too high. Also, some retailers occasionally offer on-the-spot deals, like blue-light specials.

This disclosure describes one or more example embodiments of a system, an apparatus, and a method to automate haggling in conjunction with commerce at a physical point-of-sale. In one embodiment, a shopper uses a mobile device to interact with the automated haggling system. For instance, the automated haggling system may involve one or more applications running on the shopper's cell phone, or other mobile device, as well as one or more applications running on a data processing system in a vendor's store. The automated haggling system may also involve one or more applications running on one or more remote servers.

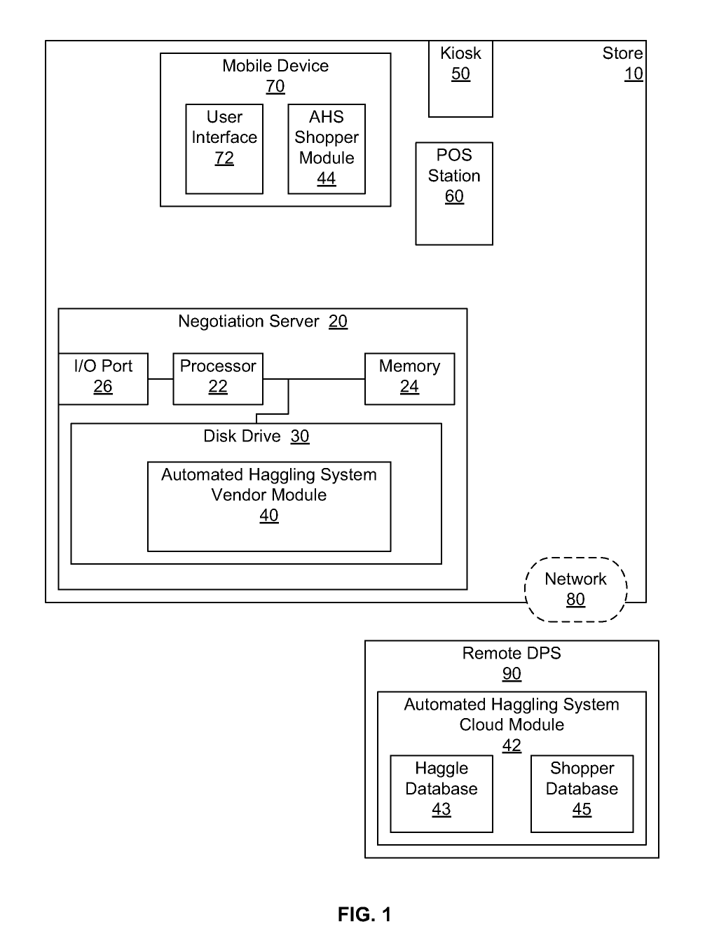

FIG. 1 is a block diagram of an example embodiment of a computing environment to provide an automated haggling service. The embodiment of FIG. 1 depicts a store 10 at which a vendor offers products for sale to shoppers. In the embodiment of FIG. 1, the store includes a data processing system 20 that runs an automated haggling system vendor module 40. Data processing system 20 may also be referred to as a negotiation server 20. As described in greater detail below, negotiation server 20 may serve as a primary interface to interact with mobile devices of shoppers who wish to use the automated haggling service. Negotiation server 20 may include various components necessary or suitable for executing vendor module 40, such as one or more processors 22, memory 24, one or more disk drives 30, various network or input/output (I/O) ports 26, and I/O devices such as a keyboard, a mouse, and a display. For instance, vendor module 40 may reside on disk drive 30, and negotiation server 20 may copy some or all of vendor module 40 into memory 24 and execute vendor module 40 on processor 22.

FIG. 1 also depicts a data processing system 70 associated with a shopper. In the embodiment of FIG. 1, that data processing system is a mobile device 70, including but not limited to a cell phone or a tablet computer. Mobile device 70 may include similar components as negotiation server 20, such as one or more processors, memory, and software stored in the memory, in a disk drive, or in some other nonvolatile storage device. Mobile device 70 also includes various user interface components 72, such as a display and a speaker. The shopper may use an automated handling system shopper module 44 on mobile device 70 to interact with automated haggling system vendor module 40.

FIG. 1 also depicts a remote data processing system 90 that runs an automated haggling system cloud module 42. As described in greater detail below, in alternative embodiments, the remote data processing system or parts thereof may be omitted. In the embodiment of FIG. 1, remote data processing system 90 may include similar components as negotiation server 20, such as one or more processors, memory, and software stored in the memory, in a disk drive, or in some other nonvolatile storage device, etc. Cloud module 42 may allow the vendor to interact with a haggle database 43 and a shopper database 45. For instance, the vendor may use vendor module 40 to instruct remote data processing system 90 to add, delete, and/or modify negotiating parameters for the vendor in haggle database 43. Alternatively, the vendor may use an Internet browser on negotiation server 20, on a different computer, or any other suitable means to communicate with cloud module 42 and/or to manipulate haggle database 43. Cloud module 42 may also allow mobile device 70 to interact with shopper database 45. For purposes of this disclosure, shopper database 45 may also be referred to as a subscriber database.

In the embodiment of FIG. 1, negotiation server 20, mobile device 70, and/or remote data processing system 90 may communicate with each other, and with other data processing systems, via one or more networks 80. For instance, in one embodiment, mobile device 70 may use wireless and/or cellular technology to communicate with the Internet, and negotiation server 20 and remote data processing system 90 may use one or more wired and/or wireless local area or wide area networks to access the Internet. In other embodiments, infrared communications, Bluetooth communications, broadband communications including but not limited to WiFi and WiMax, and any other suitable communication technology or combination of communication technologies may be used.

In one embodiment, the hardware and software components of the automated haggling system enable a shopper's electronic device and a POS station (and/or other hardware in the vendor's store) to the contextually aware of one another, and to haggle with one another. For example, in the embodiment of FIG. 1, the store includes a kiosk 50 and a point-of-sale (POS) station 60. Kiosk 50 and POS station 60 may communicate with vendor module 42 and negotiation server 20 via network 80. The shopper may use mobile device 70 to check in at kiosk 50 and to check out at POS station 60. In addition, kiosk 50 and POS station 60 may be capable of automatically detecting mobile device 70 and automatically notifying vendor module 40 that a shopper with a mobile device that supports automated haggling is at the store.

While in the store, the shopper may decide that he wants to purchase product A, but he does not want to pay full price. The automated haggling system may allow the shopper to submit a counteroffer that proposes a lower price. The automated haggling system may then automatically respond to the shopper with acceptance of the proposed price, with a new counter price, with an option to reduce the price by a specified amount if the shopper also buys products C and D, with a rejection of the proposed price, etc. For example, if the automated haggling system determines that the price in the counteroffer from the shopper is too low, the automated haggling system may generate a new counteroffer for the shopper with a price below the original price of the product and above the price in the counteroffer from a shopper. The shopper may then choose to accept or reject the new counteroffer from the vendor.

Additionally, the automated haggling system may enable the vendor to share pertinent coupons, discounts, etc. to the shopper, to entice a shopper to enter the store, to purchase items, etc. For instance, the automated haggling system may automatically generate enticement offers designed to attract a shopper into the vendor's store. These enticement offers may be based on the negotiating parameters from the haggle database. In addition, the automated haggling system may automatically generate combination offers that provide discounts to shoppers who purchase multiple different products. These combination offers may also be based on data from the haggle database.

Vendors may also use the automated haggling system to create joint deals involving products from more than one vendor. For instance, the automated haggling system may present the shopper with a deal on product X from a store that sells clothes and on product Y from a store that sells bath supplies. In addition, the automated haggling system may generate and communicate these deals and other kinds of deals dynamically. For instance, the automated haggling system may automatically send a message to the shopper offering a discount on product Y in response to determining that the shopper has purchased product X, has made a deal to purchase product X at a discount, or otherwise has expressed interest in product X. Thus, automated haggling system may use heuristics to dynamically predict product preferences for shoppers in real time Another set of compatible vendors could be a gym and a nutrition store. Combination deals with many other kinds of vendors could also be created, including deals with three or more vendors. The value of haggling may become larger, for the vendors and for the shopper, as the deal becomes more complicated. As described in greater detail below, the automated haggling system may also allow vendors to establish revenue sharing percentages for these kinds of offers, and the automated haggling system may enforce the revenue sharing arrangements at the shopper's mobile device and/or at the vendor's POS stations.

As described in greater detail below, the deals generated by the automated haggling system may also take into account the preferences of the shopper. For instance, the automated haggling system may allow the shopper to register particular culinary preferences (e.g., a preference for or against steak, a preference for vegetarian food, etc.), and the automated haggling system may then use those preferences to create any of the offers described herein.

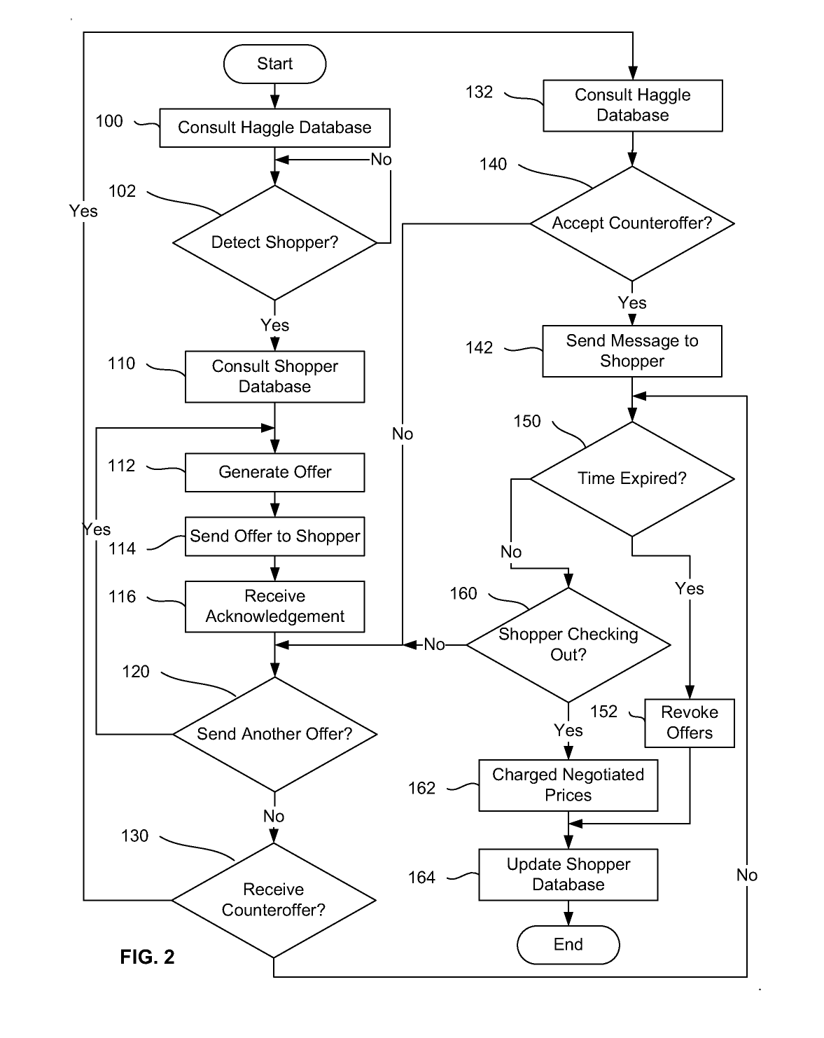

FIG. 2 is a flowchart depicting an example embodiment of a process to provide automated haggling services. That process may be performed after the vendor has stored negotiating parameters in haggle database 43. Those negotiating parameters may include minimum acceptable prices for different products, predetermined priorities as to which products are most important to sell at the current time, which products are suitable for combination offers with which other products, which products are suitable for multi-vendor offers involving products from other vendors, etc. Also, at least one shopping preference of the shopper may already have been stored in shopper database 45.

The process of FIG. 2 focuses largely on operations performed by vendor module 40, and as shown at block 100, the process of FIG. 2 starts with vendor module 40 retrieving negotiating parameters from haggle database 43. As shown that block 102, vendor module 40 may then determine whether a shopper who is equipped to practice automated haggling has been detected at the store.

To prepare for automated haggling, for a shopper may install shopper module 44 onto mobile device 70, may register with cloud module 42 and/or vendor module 40, and may create and save a shopping profile with shopping preferences in shopper database 45. For purposes of this disclosure, a human shopper who is equipped to practice automated haggling may be referred to as a “subscriber.”

Vendor module 40 may use any suitable technique or combination of techniques to detect whether a subscriber has been detected. For instance, location-based services running on mobile device 70 may automatically notify vendor module 40 that the shopper is at the store in response to detecting that the current location of mobile device 70 corresponds to the location of the store. Shopper module 44 may use a global positioning system (GPS) in mobile device 70 (or any other suitable technology) to determine the location of mobile device 70. Shopper module 44 may determine the location of stores that allow automated haggling, based on information from cloud module 42. Alternatively, mobile device 70 and hardware in the store, such as kiosk 50 or POS station 60, may use near field communication (NFC), Bluetooth communications, and/or any other suitable communication technologies or combination of technologies to share information and recognize each other when within a certain proximity from each other. Alternatively, shopper module 44 may provide information and options in user interface 72 to allow the shopper to manually check in at the store.

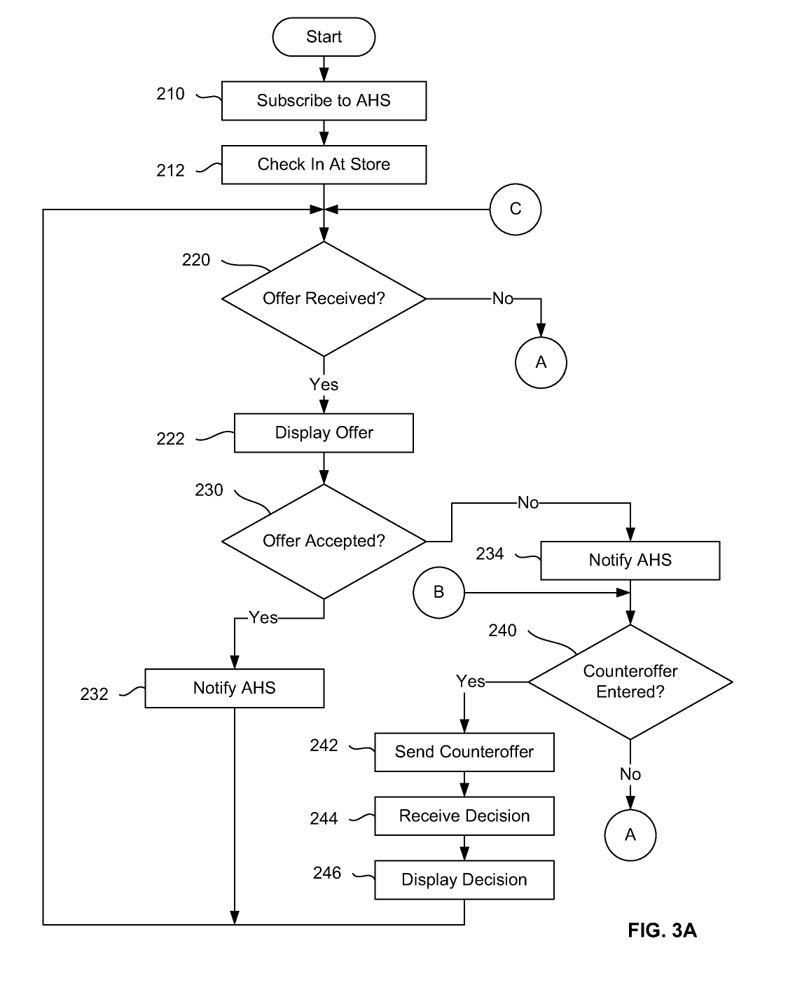

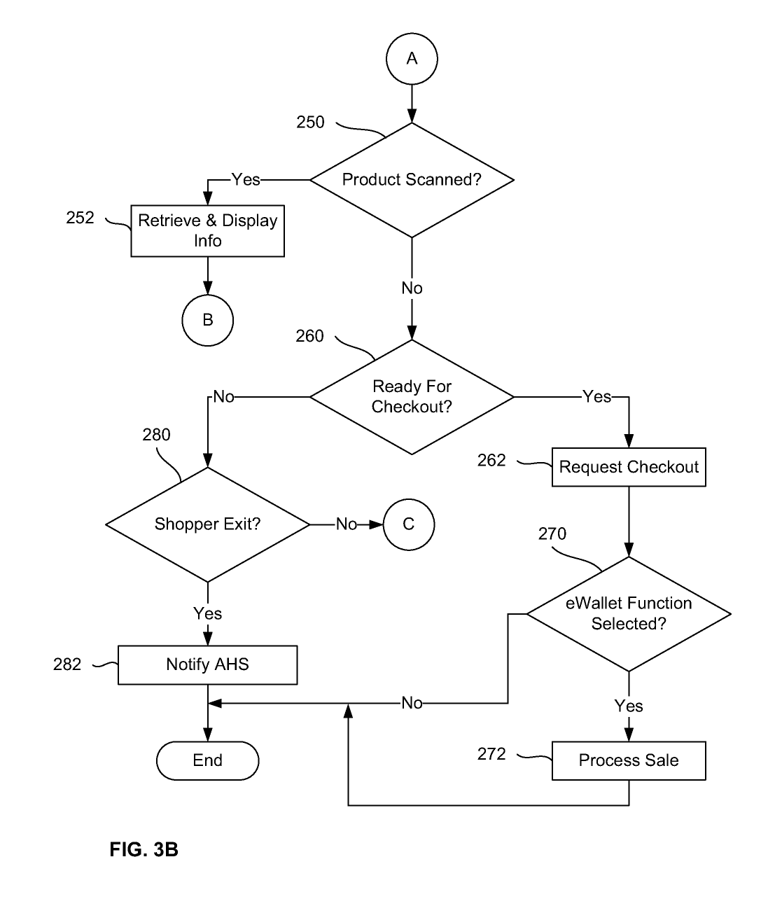

As shown that block 110, in response to detecting a subscriber, vendor module 40 may automatically retrieve information concerning that shopper from shopper database 45. This information may be referred to as the shopper's profile. As described in greater detail below with regard to FIG. 3B, cloud module 42 may allow the shopper to customize his shopping profile with various shopping (preferences. The shopper may specify preferences via shopper module 44, through in Internet browser on a different computer, or through any other suitable means. The shopping profile may also include information about shopping preferences or habits of the shopper that has been obtained from a customer loyalty program, from a frequent shopper program of the vendor, or from other sources.

As shown that block 112, vendor module 40 may then automatically generate an offer, based on the shopping profile from shopper database 45 and the negotiation parameters from haggle database 43. Depending on the negotiation parameters, the shopper profile, and the stage of the haggling process, the automated haggling system may automatically decide to generate many different kinds of offers. For instance, in response to first detecting the shopper in or near the store, the automated haggling system may generate an enticement offer that includes one or more reduced prices intended to lure the shopper into the store and/or to entice the shopper to buy one or more particular products. Or, if the shopper has proposed a counteroffer for a product, the automated haggling system may generate a new counteroffer, as described in greater detail below. Alternatively, the automated haggling system may generate a combination offer that provides a discount on at least one specific product, if that product is purchased along with another specified product.

Or, the automated haggling system may generate a multi-vendor offer that is like a combination offer, but involving two or more different products sold by two or more different vendors. For example, the automated haggling system may generate multi-vendor offers that involve complementary items that are not carried by the same vendor. Such offers may be haggled and stored in the cloud. To realize the savings, the shopper may need to check out at POS stations in retail stores for each of the various vendors. Upon identification of the shopper at each POS station or terminal, the deal will be retrieved, and the discounted amount (e.g., the difference between original or list price and the negotiated price) may be stored in the cloud and tagged for rebate upon completion of the overall deal. Upon the shopper's completion of the last purchase at the last vendor, the discount for the last product may be applied. In addition, a rebate for the cumulative differences between the original prices and the deal prices for all of the other products in the deal may be issued to the shopper via any suitable technique (e.g., via credit card). Also, upon completion of the deal, the automated haggling system may enforce a prearranged revenue sharing arrangement between the vendors. Such arrangements may provide incentives for the vendors to team up.

For instance, Black's Gym and White's Nutrition Center may decide to participate in a multi-vendor offer that provides a discount on gym membership if the shopper also buys a particular food item from the nutrition center. For example, the regular price of gym membership may be $75, and the regular price of the food item may be $25. In addition, the vendors may configure the automated haggling system to generate an offer in which membership only costs $65, and the food item only costs $20, if the shopper purchases both of those products. In response to detecting a shopper at Blank's Gym, the automated haggling system may automatically offer such a deal to the shopper, and the shopper may accept it. The shopper may then pay $75 at Black's Gym for the membership. The shopper may then complete the deal by paying $20 for the food item at White's Nutrition Center. And upon completion of the deal, the automated haggling system may cause a $10 refund to be posted to the shopper's credit card (or may otherwise generate a $10 rebate or credit for the customer), to reduce the final cost of the membership to $65, as agreed. In addition, the automated haggling system may provide for one or more of the vendors to receive a prearranged percentage of the sale price received by one or more of the other vendors. For instance, the automated haggling system may cause Black's Gym to receive 0.5% of the $20 sale price from White's Nutrition Center, for encouraging the shopper to purchase from White's Nutrition Center.

In addition, the automated haggling system may generate hybrid offers that combine characteristics of the other offers described herein. For instance, the automated haggling system may generate an enticement offer or anew counteroffer that is also a multi-vendor offer.

As shown at block 114, after generating an offer, vendor module 40 may then automatically send the offer to mobile device 70. Any suitable technique or combination of techniques may be used to convey offers, counter offers, and other communications between shopper module 44, vendor module 40, and/or cloud module 42, including text messages, data communication via NFC, cellular, Bluetooth, infrared, or other wireless communication technologies, etc. In one embodiment, secure communication techniques are used.

The automated haggling system may also allow the shopper to share the deal with others. For instance, if vendor module 40 sends the enticement offer to the shopper via e-mail, the shopper may forward the e-mail to others. Alternatively, if the automated haggling system provides notification via shopper module 44, the shopper may use suitable options provide by shopper module 44 to share the offer with others.

As shown that block 116, vendor module 40 may then receive a message from shopper module 44 indicating that the shopper has acknowledged being at the store (i.e., in, or in the vicinity of, the store), that the shopper has acknowledged receipt of the offer, that the shopper has accepted the offer, or that the shopper has rejected the offer. If the shopper has accepted the offer, data indicating such acceptance may be stored by vendor module 40 and/or cloud module 42 for use at checkout.

As shown at block 120, vendor module 40 may then automatically determine whether or not to send another offer to the shopper. This determination may also be made based on information from haggle database 43 and from shopper database 45. For instance, haggle database 43 may identify numerous products that the vendor is willing to sell at reduced prices, shopper database 45 may identify numerous products or types of products as likely to be of interest to the shopper, and vendor module 40 may cross reference haggle database 43 and shopper database 45 to identify numerous products as being of potential interest to the shopper. At block 120, vendor module 40 may decide to generate another offer involving one of those products. Alternatively, if the process has returned to block 120 after passing through block 140, vendor module 40 may decide to send a new counteroffer to the shopper, in response to receiving an unacceptable counteroffer, from the shopper. If vendor module 40 decides that another offer should be sent, the process may return to block 112, and vendor module 40 may automatically generate and send the new offer, as indicated above.

If vendor module 40 decides not to send a new offer, vendor module 40 may determine whether it has received a counteroffer from mobile device 70, as shown at block 130. If so, as shown at blocks 132 and 140, vendor module 40 may retrieve negotiating parameters from haggle database 43 and use that information to automatically decide whether or not to accept the counteroffer. In response to a determination to reject the counteroffer, the process may return to block 120, with vendor module 40 deciding whether to send another offer to the shopper. However, in response to a decision to accept the counteroffer, vendor module 40 may send a message to mobile device 70 indicating that the counteroffer has been accepted, as depicted at block 142. In addition, data indicating such acceptance may be stored by vendor module 40 and/or cloud module 42 for use at checkout.

As shown at block 150, vendor module 40 may then determine whether the offers that have been extended to the shopper have passed an expiration period. If so, vendor module 40 may revoke those offers, as indicated at block 152. Vendor module 40 may also update shopper database 45 with information pertaining the latest activities of the shopper, such as which products were inquired about, which offers were accepted, etc. The process may then end.

However, referring again to block 150, if there is an unexpired offer, the process may pass to block 160, with vendor module 40 determining whether the shopper is checking out. Any suitable technique may be used to determine whether the shoppers checking out, including NFC communications or other communications between mobile device 70 and POS station 60. If the shopper is not checking out, the process may return to block 120. However, if the shopper is checking out, vendor module 40 may cause POS station 60 to charge a reduced price for one or more products being purchased by the shopper, in accordance with any agreements reached during the automated haggling process. As indicated at block 164, vendor module 40 may then update shopper database 45 with information pertaining the latest activities of the shopper, such as which products were inquired about, which offers were accepted, which products were purchased, etc. The process may then end.

In some alternative embodiments, the remote data processing system may be omitted, and the corresponding services, databases, etc., may instead be provided by a data processing system such as the negotiation server in the store. In other embodiments, some or all of the operations depicted in FIG. 2 may be performed by data processing systems other than negotiation server 20. For example, cloud module 42 in remote data processing system 90 may perform the operation at block 102, detecting that a shopper who has subscribed to the automated haggling system is in or near a store of a vendor that has subscribed to the automated haggling system. Cloud module 42 may then perform the operations at blocks 110, 112, 114, 116, 120, 130, 132, 140, 142, 150, 152, 160, 162, and 164. Alternatively, for blocks 160 and 162, cloud module 42 and vendor module 40 may cooperate to consummate the checkout process in according with the terms previously negotiated using the automated haggling system. Additionally, portions of vendor module 40, or other modules of the automated haggling system, may run on kiosk 50 and POS station 60. Alternatively, in some embodiments, negotiation server 20 and/or kiosk 50 may be omitted, and vendor module 40 may run on POS station 60 and/or kiosk 50, and the vendor may use any suitable data processing system to interact with cloud module 42, for instance to update haggle database 43 with new negotiating parameters.

FIGS. 3A & 3B present a flowchart of an example embodiment of a process for using automated haggling services to shop, with a focus on operations performed by mobile device 70. The process starts at block 210, with a shopper subscribing to the automated haggling system. Then, at block 212, shopper module 44 checks in at the store. For instance, as indicated above, the shopper may check in by using mobile device 70 to communicate with a kiosk 50. At block 220, shopper module 44 deter whether an offer has been received from vendor module 40. If an offer has been received, shopper module 44 displays the offer in user interface 72. Shopper module 44 and then determines whether the shopper has accepted the offer, as shown at block 230. If the shopper has accepted the offer, shopper module 44 notifies vendor module 40, as shown at block 232. The process may then return to block to 220, with a shopper module 44 waiting to receive additional offers from the vendor.

However, referring again to block 230, if a shopper has rejected the offer, shopper module 44 may notify vendor module 40 about the rejection, as shown at block 234. Shopper module 44 may then determine whether the shopper has entered a counteroffer via user interface 72, as shown at block 240. Shopper module 44 may provide specific fields, drop down boxes, or other mechanisms for the shopper to select to make a counteroffer and to specify terms such as price for the counteroffer. If no counteroffer has been entered, the process may pass through page connector A to FIG. 3B. The process may also pass from block 220 through page connector A to FIG. 3B if no offer is received.

However, referring again to block 240, if the user has entered a counteroffer, shopper module 44 may send the counteroffer to vendor module 40, as shown that block 242. Shopper module may use one or more predetermined data structures for such counteroffers, to allow such electronic counteroffers to be easily understood and processed by vendor module 40. As shown at block 244, shopper module may then receive a decision from vendor module 40 indicating whether or not the counteroffer has been accepted. As shown that block 246, shopper module 44 may display that decision in user interface 72. The process may then return to block 220, with shopper module 44 waiting for another offer from vendor module 40.

After the process passes through page connector A to FIG. 3B, as shown at block 250, shopper module 44 may then determine whether the shopper has scanned in information about a product. For instance, the shopper may use mobile device 72 scan in a bar code or other product identifier for a product of interest to the shopper. If the product information has been scanned or otherwise inputted, shopper module 44 retrieves further information about the product and displays the information in user interface 72, as shown at block 252. For instance, shopper module 44 may obtain information about the product from an electronic catalog of the vendor, from haggle database 43, and/or from other sources. The product information may include the price at which the vendor is currently offering the product for sale to all shoppers. In addition, shopper module 44 may present options in user interface 72 to enable the shopper to propose a different price for the product, and to request submission of that price to the vendor in a counteroffer.

The process may then return to FIG. 3A, via page connector B, and shopper module 44 may then determine whether the shopper has entered a counteroffer, as shown at block 240 and described above.

Referring again to block 250 of FIG. 3B, if a product has not been scanned, shopper module 44 may determine whether the shopper is ready for checkout, as indicated at block 260. For example, shopper module 40 may determine that the shopper is ready for checkout in response to communications between mobile device 70 and POS station 60, or in response to the shopper selecting a check out function of shopper module 44. As shown at block 262, if the shopper is ready for checkout, shopper module 44 may send a message to vendor module 40 requesting checkout. Shopper module 44 may then determine whether the shopper has selected an option to use mobile device 70 to pay for the products. For instance, mobile device 70 may feature an NFC secure element for securely managing vendor credentials and haggling policies and for securely executing those policies, and shopper module 44 may use the NFC secure element provide the shopper with a PCI compliant eWallet protocol to pay for products. Alternatively or in addition, mobile device 70 may use one or more other kinds of security engine for those kinds of functions. Mobile device 70 may also use the NFC secure element (and/or other security features) to securely store, manage, and/or execute policies and credentials of other interested parties, such as banks, credit card companies, etc.

If the shopper is not ready for checkout, shopper module 44 may determine whether the shopper is exiting the store, as shown at block 280. For example, shopper module 40 may determine that the shopper is exiting the store in response to location information from the GPS of mobile device 70, or in response to the user manually selecting a store exit function of shopper module 44. If the shopper is leaving the store, shopper module 44 may notify vendor module 40, as indicated that block 282, and the process may then end. Otherwise, if the shopper is not leaving, the process may return to block 220 of FIG. 3A via page connector C.

In one embodiment, the automated haggling system provides for secure mobile commerce (M-commerce), using centralized backend components that use a cloud computing architecture for storing data, for providing application functionality, and for communicating with other components of the system, including a downloadable application for a client computing device. The cloud service allows vendor management to easily dial in particular business parameters. For instance, default negotiating parameters for all stores in a national chain of stores may be stored in haggle database 43 by personnel at the vendor's national headquarters. Additional or different negotiating parameters for all stores within a region may be stored in haggle database 43 by personnel at the regional headquarters. Furthermore, additional or different negotiating parameters for a particular store may be stored in haggle database 43 by the management of that store. The automated haggling system allows the retailer to dial in its sales parameters into the cloud application so the shoppers can work to an acceptable price based on the retailer's current business needs. For instance, the automated haggling system may generate offers and counteroffers based on negotiating parameters which indicate that X sales should be made today, even if the price were dropped to Y, or that the automated haggling system should push sales of ties by generating combination offers that give discounts on shirts when bought together with the ties.

In one embodiment, the automated haggling system also allows the haggle prices for items to be downloaded to the point of sale for the shopper to claim. The various components of the automated haggling system may handle transactions and communication in a secure manner. For instance, shopper module 44 may use secure communication with vendor module 40 and/or with cloud module 42. Also, contextually aware capabilities on the shopper's device may allow the device to be sensed or detected, especially (but not limited to) while in close proximity to the retailer's establishment.

In one embodiment, the automated haggling system is operated by a service provider who charges vendors for use of the system (e.g., an initial setup fee, an annual subscription fee, a small fee for each sale, etc.).

This disclosure refers to products sold by vendors. For purposes of this disclosure, unless specifically provided otherwise, the term “product” is not limited to goods, but includes goods and services.

In light of the principles and example embodiments described and illustrated herein, it will be recognized that the illustrated embodiments can be modified in arrangement and detail without departing from such principles. Also, the foregoing discussion has focused on particular embodiments, but other configurations are contemplated. Also, even though expressions such as “in one embodiment,” “in another embodiment,” or the like are used herein, these phrases are meant to generally reference embodiment possibilities, and are not intended to limit the invention to particular embodiment configurations. As used herein, these terms may reference the same or different embodiments that are combinable into other embodiments.

Also, devices that are described as being in communication with each other or as being responsive to each other need not be in continuous communication with each other, unless expressly specified otherwise. In addition, devices that are described as being in communication with each other or as being responsive to one another may communicate directly or indirectly through one or more intermediaries.

It should also be understood that the hardware and software components depicted herein represent functional elements that are reasonably self-contained so that each can be designed, constructed, or updated substantially independently of the others. In alternative embodiments, many of the components may be implemented as hardware, software, or combinations of hardware and software for providing the functionality described and illustrated herein. For example, alternative embodiments include machine accessible media encoding instructions or control logic for performing the operations of the invention. Such embodiments may also be referred to as program products. Such machine accessible media may include, without limitation, tangible storage media such as floppy disks, hard disks, CD-ROMs, ROM, RAM, flash memory, etc. Also, the control logic for implementing the described operations be implemented in hardware logic (e.g., as part of an integrated circuit chip, a programmable gate array (PGA), an application specific integrated circuit (ASIC), etc.). Instructions may also be used in a distributed environment, and may be stored locally and/or remotely for access by single or multi-processor machines.

Similarly, although example processes have been described with regard to particular operations performed in a particular sequence, numerous modifications could be applied to those processes to derive numerous alternative embodiments of the present invention. For example, alternative embodiments may include processes that use fewer than all of the disclosed operations, processes that use additional operations, and processes in which the individual operations disclosed herein are combined, subdivided, rearranged, or otherwise altered.

In view of the wide variety of useful permutations that may be readily derived from the example embodiments described herein, this detailed description is intended to be illustrative only, and should not be taken as limiting the scope of the invention. What is claimed as the invention, therefore, are all implementations that come within the scope of the following claims and all equivalents to such implementations.

1-23. (canceled)

24. A method to automate business negotiations, the method comprising:
offering a product of a vendor for sale according to an original set of one or more sales terms;
receiving a counteroffer to buy the product from a data processing system of a shopper, wherein the counteroffer is received by an automated haggling system of the vendor, and the counteroffer proposes at least one different sales term for the product;
in response to receiving the counteroffer at the automated haggling system, automatically determining whether the counteroffer results in an acceptable set of sales terms for the product; and
in response to determining that the counteroffer results in an acceptable set of sales terms, sending a message to the data processing system of the shopper to signify acceptance the counteroffer by the vendor.

25. A method according to claim 24, wherein:
the original set of sales terms comprises an original price for the product; and
the at least one different sales term of the counteroffer comprises a new price for the product.

26. A method according to claim 25, further comprising:
determining whether the shopper is purchasing the product at a point-of-sale station; and
in response to determining that the shopper is purchasing the product, automatically charging the shopper the new price for the product.

27. A method according to claim 25, wherein the automated haggling system automatically determines whether the counteroffer proposes an acceptable price based at least in part on data from a negotiation database that comprises:
product identification data that identifies the product; and
product discount data that identifies a predetermined reduced price for the product as acceptable to the vendor.

28. A method according to claim 27, further comprising:
in response to a determination that the counteroffer does not propose an acceptable price for the product, automatically determining a new proposed price for the product at a level that is (a) at least as high as the predetermined reduced price and (b) lower than the original price, and automatically sending a message to the data processing system of the shopper to signify a new counteroffer with the new proposed price; and
receiving a message from the data processing system of the shopper to signify acceptance the new counteroffer.

29. A method according to claim 24, wherein the product comprises a first product, the method further comprising:
automatically generating a combination offer involving the first product and at least one additional product, based at least in part on data from a negotiation database, wherein the combination offer involves a discounted price for at least one product from the group consisting of the first product and the additional product;
in response to receiving the counteroffer from the data processing system of the shopper, automatically sending a message to the data processing system of the shopper to propose the combination offer to the shopper; and
receiving a message from the data processing system of the shopper to signify acceptance the combination offer by the shopper.

30. A method according to claim 24, wherein the product comprises a first product, the vendor comprises a first vendor, and the method further comprises:
generating a multi-vendor offer involving the first product and at least one second product from a second vendor, based at least in part on product discount data from the first vendor and product discount data from the second vendor, wherein the multi-vendor offer involves a discounted price for at least one product from the group consisting of the first product and the second product;
sending a message to the data processing system of the shopper to propose the multi-vendor offer to the shopper; and
receiving a message from the data processing system of the shopper to signify acceptance the multi-vendor offer by the shopper.

31. A method according to claim 24, further comprising:
accessing a subscriber database that identifies shoppers who have registered for participation in automated negotiations, and that identifies product preferences for shoppers, wherein the shoppers identified as having registered in the subscriber database comprise subscribers;
automatically detecting a nearby subscriber from among the subscribers;
generating an enticement offer for the nearby subscriber, based at least in part on (a) product preference data for the nearby subscriber from the subscriber database, and (b) product discount data from a negotiation database; and
in response to detecting the nearby subscriber, automatically sending a message to a mobile device of the nearby subscriber to propose the enticement offer to the nearby subscriber.

32. A method according to claim 31, wherein the operation of automatically detecting a nearby subscriber from among the subscribers comprises:
automatically determining whether one of the subscribers is in or near a store controlled by the vendor.

33. A method according to claim 31, wherein the automated haggling system automatically recognizes subscribers to be nearby subscribers in response to detecting mobile devices of the nearby subscribers in or near a store controlled by the vendor.

34. A method according to claim 24, wherein the product comprises at least one item from the group consisting of a good and a service.

35. A data processing system comprising:
at least one processor;
a tangible machine accessible medium responsive to the processor; and
instructions in the machine accessible medium which, when executed, implement an automated haggling system for a vendor, the automated haggling system operable to perform operations comprising:
for a product offered for sale by the vendor, associating the product with an original set of one or more sales terms;
receiving, from a data processing system of a shopper, a counteroffer that proposes at least different sales term for the product;
in response to receiving the counteroffer, automatically determining whether the counteroffer results in an acceptable set of sales terms for the product; and
in response to determining that the counteroffer results in an acceptable set of sales terms, sending a message to the data processing system of the shopper to signify acceptance the counteroffer by the vendor.

36. A data processing system according to claim 35, wherein:
the original set of sales terms comprises an original price for the product; and
the at least one different sales term of the counteroffer comprises a new price for the product.

37. A data processing system according to claim 36, wherein the automated haggling system is further operable to perform operations comprising:
determining whether the shopper is purchasing the product at a point-of-sale station; and
in response to determining that the shopper is purchasing the product, automatically charging the shopper the new price for the product.

38. A data processing system according to claim 36, wherein the automated haggling system automatically determines whether the counteroffer proposes an acceptable price based at least in part on data from a negotiation database that comprises:
product identification data that identifies the product; and
product discount data that identifies a predetermined reduced price for the product as acceptable to the vendor.

39. A data processing system according to claim 38, wherein the automated haggling system is further operable to perform operations comprising:
in response to a determination that the counteroffer does not propose an acceptable price for the product, automatically determining a new proposed price for the product at a level that is (a) at least as high as the predetermined reduced price and (b) lower than the original price, and automatically sending a message to the data processing system of the shopper to signify a new counteroffer with the new proposed price; and
receiving a message from the data processing system of the shopper to signify acceptance the new counteroffer.

40. A data processing system according to claim 35, wherein the automated haggling system is further operable to perform operations comprising:
accessing a subscriber database that identifies shoppers who have registered for participation in automated negotiations, and that identifies product preferences for shoppers, wherein the shoppers identified as having registered in the subscriber database comprise subscribers;
automatically detecting a nearby subscriber from among the subscribers;
generating an enticement offer for the nearby subscriber, based at least in part on (a) product preference data for the nearby subscriber from the subscriber database, and (b) product discount data from a negotiation database; and
in response to detecting the nearby subscriber, automatically sending a message to a mobile device of the nearby subscriber to propose the enticement offer to the nearby subscriber.

41. A data processing system according to claim 40, wherein the operation of automatically detecting a nearby subscriber from among the subscribers comprises:
automatically determining whether one of the subscribers is in or near a store controlled by the vendor.

42. An automatically haggling system comprising:
a vendor module to execute at least partially on a data processing system of a vendor that offers a product for sale at an original price;
a shopper interface in the vendor module configured to receive a counteroffer concerning the product from a mobile device of a shopper, wherein the counteroffer proposes a different price for sale of the product to the shopper; and
an offer consideration module in the vendor module, the offer consideration module configured to automatically determining whether the counteroffer proposes an acceptable price for the product, in response to receipt of the counteroffer;
wherein the vendor module is configured to automatically send a message to the mobile device of the shopper to signify acceptance the counteroffer by the vendor, in response to determining that the counteroffer proposes an acceptable price.

43. An automated haggling system according to claim 42, further comprising:
a shopper module to execute on the mobile device of the shopper, the shopper module configured to provide the shopper with an interface to specify the different price for the product; and
a vendor interface in the shopper module to enable the shopper module to send the counteroffer to the vendor module and to receive the message from the vendor module signifying acceptance the counteroffer by the vendor.

44. An automated haggling system according to claim 42, wherein the vendor module is conjured to perform operations comprising:
determining whether the shopper is purchasing the product at a point-of-sale (POS) station of the vendor; and
in response to determining that the shopper is purchasing the product, automatically causing the POS station to charge the shopper the price from the counteroffer for the product.

45. An automated haggling system according to claim 42, further comprising:
a negotiation database having product identification data that identifies the product and having product discount data that identifies a predetermined reduced price for the product as acceptable to the vendor; and
wherein the offer consideration module is configured to automatically determine whether the counteroffer proposes an acceptable price, based at least in part on data from the negotiation database.

46. An automated haggling system according to claim 45, wherein the vendor module is configured to perform operations comprising:
in response to a determination that the counteroffer does not propose an acceptable price for the product, automatically determining a new proposed price for the product at a level that is (a) at least as high as the predetermined reduced price and (b) lower than the original price;
after determining the new proposed price, automatically sending a message to the mobile device of the shopper to signify a new counteroffer with the new proposed price; and
receiving a message from the mobile device of the shopper to signify acceptance the new counteroffer.

47. An automated haggling system according to claim 42, further comprising:
a subscriber database that identifies shoppers who have registered for participation in automated negotiations, and that identifies product preferences for shoppers, wherein the shoppers identified as having registered in the subscriber database comprise subscribers; and
wherein the vendor module is configured to perform operations comprising:
automatically detecting a nearby subscriber from among the subscribers;
generating an enticement offer for the nearby subscriber, based at least in part on (a) product preference data for the nearby subscriber from the subscriber database, and (b) product discount data from a negotiation database; and
in response to detecting the nearby subscriber, automatically sending a message to a mobile device of the nearby subscriber to propose the enticement offer to the nearby subscriber.

48. An article of manufacture comprising:
a tangible machine accessible medium; and
instructions in the machine accessible medium which, when executed by a mobile device of a shopper, enable the mobile device to perform the operations comprising:
sending a message from the mobile device of the shopper to an automated haggling system of a vendor, wherein the message notifies the automated haggling system that the shopper is at a store of the vendor;
at the mobile device, detecting a query from the shopper about a product offered for sale in the store, wherein the query comprises information to identify the product;
in response to detecting the query, automatically presenting information about the product to the shopper, via a user interface of the mobile device, wherein the information about the product comprises an original price for the product set by the vendor;
via the user interface of the mobile device, presenting the shopper with an option to propose a reduced price for the product;
in response to a determination that the shopper has utilized the option to propose the reduced price for the product, sending a counteroffer to the automated haggling system, wherein the counteroffer specifies the proposed reduced price; and
receiving an automated response from the automated haggling system, wherein the automated response indicates whether or not the automated haggling system has accepted the proposed reduced price.

49. An article of manufacture according to claim 48, wherein the instructions enable the mobile device of the shopper to perform further operations comprising:
when the shopper is ready to checkout, sending information to identify the shopper from the mobile device to a point-of-sale (POS) station of the vendor, to enable the POS station to automatically charge the shopper the reduced price for the product.

50. An article of manufacture according to claim 49, wherein the instructions enable the mobile device of the shopper to perform further operations comprising:
during checkout, sending payment information for the product from the mobile device to the POS station.
